(19) United States
(12) Patent Application Publication
(10) Pub. No.: US 2012/0037079 A1
(43) Pub. Date: Feb. 16, 2012

(54) METHODS, APPARATUS AND PRODUCTS FOR FEEDING ANIMALS

(76) Inventors: MARK RASMUSSEN, Louise, TX (US); Melvin Rasmussen, Hallettsville, TX (US)

(21) Appl. No.: 12/854,211

(22) Filed: Aug. 11, 2010

(51) Int. Cl. A01K 5/01

(52) U.S. Cl. 119/52.3; 119/52.1; 119/54

(57) ABSTRACT

An animal feeder having a feed reservoir for storing flowable solid animal feed, a feed zone receiving animal feed from the feed reservoir, and a tray pivotally attached below the feed zone, the tray being pivotable between a first position and a second position.

### BACKGROUND OF THE INVENTION

1. Field of the Invention

The present invention relates to apparatus, methods and products for feeding animals. In another aspect, the present invention relates to apparatus, methods and products for feeding animals with mechanism to deter squirrels, rodents, and/or other pests.

2. Description of the Related Art

Animal feeders are utilized for a number of applications. Farmers and ranchers utilize animal feeders for conveniently providing feed to livestock. Sportsmen utilize animal feeders to attract game animals to a certain area.

U.S. Pat. No. 5,195,458 issued Mar. 23, 1993, to Black et al., discloses a block feeder for feeding animals such as cattle, sheep, goats, deer, and the like. The block feeder comprises a feed bin, support bar, and leg structure. The feed bin has an open bottom and the feed blocks are supported by the support bar so that a portion of the bottom feed blocks are exposed to the animals. The feed bin keeps the feed blocks dry, which minimizes spoilage and allows the block feeder to be restocked less frequently. As the animals consume the feed blocks, the feed blocks slide downward, exposing more of the feed block to the animals. The block feeder also may include a tray located beneath the feed block so that waste of scrap feed falling from the feed block is minimized.

U.S. Pat. No. 5,881,672, issued Mar. 16, 1999, to Pound et al., discloses a device and method for application of collars to deer and other wild or domestic animals, that may also be employed in combination with an animal feeder or bait station to attract animals in the wild. The apparatus may be adapted for use with collars formed from flexible, relatively non-resilient material which have attachable ends, as well as collars formed from resiliently coiled materials. The apparatus includes a support assembly for holding a collar in an open position with its ends spaced apart from one another, and a trigger for effecting application of the collar when an animal places its neck over the support. When flexible, non-resilient collars are employed, the support is also adapted to propel at least one end of the collar about the animal's neck and contact the opposite end of the collar.

U.S. Pat. No. 6,481,374, issued Nov. 19, 2002, to Lillig, discloses a deer feeder adapted for hanging in a tree. The feeder includes an upright tubular feed reservoir. A feeding port angles upwardly from and communicates with the feed reservoir proximate its bottom end. In a first embodiment of the feeder, a flexible support member such as a chain is connected to the reservoir proximate its top end and so as to be engageable with the tree to suspend the feeder therefrom and a cleat extends outwardly from the feed reservoir and engages the tree trunk in order to stabilize the feeder relative to the tree. In a second embodiment, the exterior surface of the feeder is corrugated so as to include a plurality of transverse ridges separated by grooves. The feeder is connected to a tree trunk by flexible securement members which encircle the feeder and engage the grooves on the exterior surface.

U.S. Pat. No. 6,571,734, issued Jun. 3, 2003, to Finklea, discloses a wild game feeder which channels feed to feed ports through channels in an insert. The game feeder has a feed chamber with a flared base, preferably conical. An insert, fits reversibly into the flared base. When feed is added to the feed chamber the insert distributes the feed evenly in the flared base and directs the feed uniformly through channels by gravity to the feed ports in the base. As the feed spills from the feed ports to the ground, the feed accumulates at the feed ports so as to prevent further spillage until an animal consumes the feed. The flared contour of the base prevents deer from injuring their growing antlers on the feed chamber as they feed.

U.S. Pat. No. 6,564,746, issued May 20, 2003, to Burnham, discloses a squirrel-powered game feeder that is suspended alongside a tree trunk or other structure and utilizes the energy produced by live squirrels to dispense granular feed from a storage hopper to deer and other animals on the ground. The feeder assembly consists of a tubular feed container with a horizontal platform mounted on the bottom, a port hole for allowing feed particles to spill out onto the platform, and a simple agitating device that sweeps feed particles off the platform to the ground below. The agitating device is activated by the force generated by the weight and momentum of squirrels leaping back and forth from the tree trunk to the platform. The feeder works only during daytime hours when squirrels are active, and it cannot be accessed by any wildlife except squirrels and birds. If shelled corn is mainly used in the feeder, very little of it will be consumed by the squirrels themselves. They will eat only the small tip of a kernel, whereas the deer, hogs, turkeys, raccoons and other animals on the ground will readily eat all of it.

U.S. Pat. No. 6,990,925, issued Jan. 31, 2006, to Banks et al., discloses a portable deer and game feeder that includes a tub-like feeder box, a support frame for supporting the feeder box, the support frame including a plurality of removable legs for supporting the feeder box above the ground, and a roof extending over the feeder box and being large enough to overhang the edges of the feeder box. A plurality of removable roof support posts are provided for supporting the roof over the feeder box, and the removable legs and the removable roof supports are sized and configured to be detached and stowed in the feeder box for transport.

U.S. Pat. No. 7,296,538, issued Nov. 20, 2007, to Pridgen, discloses a deer feeder for holding a food container such as a jar of peanut butter. The deer feeder includes a support structure that extends upwardly from the ground and a food container holder, in the form of a sleeve, mounted to an upper portion of the support. The food container holder includes a pair of stops with at least one of the stops being movable between first and second positions. When the food container is opened and placed within the food container holder, the stops engage the food container and prevent the food container from falling from the food container holder or from being pushed from the food container holder.

One problem with animal feeders is that the feed is subject to theft by undesirable species, especially small mammalian pests, such as squirrels, rats, mice, possum??, beaver???, . . . what else might get into the feed?

There is a need in the art to provide another hurdle to theft of animal feed from animal feeders by undesirable species, especially small mammalian pests.

These and other needs in the art will become apparent to those of skill in the art upon review of this specification, including its drawings and claims.

### SUMMARY OF THE INVENTION

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

It is one object of the present invention to provide another hurdle to theft of animal feed by undesirable species, especially small mammalian pests.

These and other objects will become apparent to those of skill in the art upon review of this specification, including its drawings and claims.

According to one non-limiting embodiment of the present invention, there is provided an animal feeder having a feed reservoir for storing flowable solid animal feed, a feed zone receiving animal feed from the feed reservoir, and a tray pivotally attached below the feed zone, the tray being pivotable between a first position and a second position.

According to another non-limiting embodiment of the present invention, there is provided an animal feeder having a feed reservoir, flowable solid animal feed positioned in the reservoir, a feed zone receiving animal feed from the feed reservoir, and a tray pivotally attached below the feed zone, the tray being pivotable between a first position and a second position.

These and other embodiments will become apparent to those of skill in the art upon review of this specification, including its drawings and claims.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIGS. 1-3 show various views of one non-limiting embodiment of animal feeder 100 of the present invention, having support framing 115, feed reservoir 102, feed chutes 105, feed zones 108, and pivotable tray 110 in an upwardly position.

FIG. 4 shows animal feeder 100 of FIGS. 1-3, showing pivotable tray 110 in a downward position.

### DETAILED DESCRIPTION OF THE INVENTION

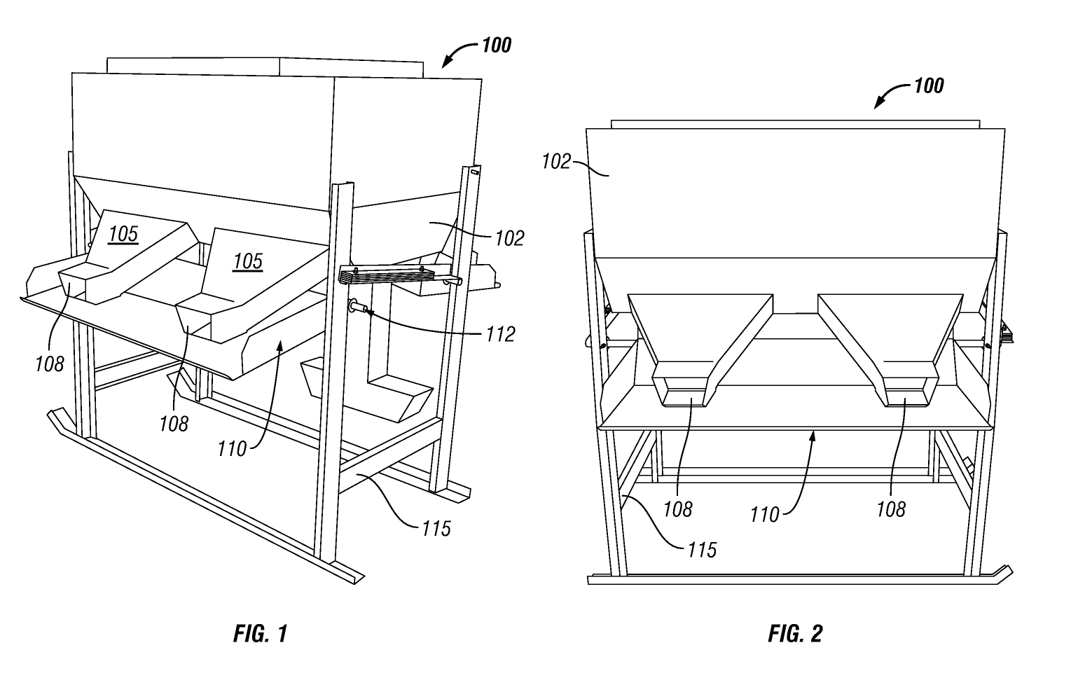

Referring now to FIGS. 1-3, there are shown various views of one non-limiting embodiment of animal feeder 100 of the present invention, having support framing 115, feed reservoir 102, feed chutes 105, feed zones 108, and pivotable tray 110.

Animal feeder 100 may include a support framing 115 that may comprise any suitable configuration for supporting the various components of animal feeder 100. Support 115 may be configured to support feed reservoir 102 up off of the ground as shown. In a non-limiting embodiment, not shown, the support framing 115 may be configured to allow feed reservoir 102 to hang from support framing 115.

Animal feeder 100 may include a reservoir 102 that will have a suitable volume to hold a desired amount of solid animal feed. As a non-limiting example, reservoir 102 may be sized to hold anywhere from tens of pounds of animal feed, to hundreds of pounds of animal feed, to thousands of pounds of animal feed or more. Solid animal feed suitable for use with animal feeder 100 may be granular in nature, and may be a flowable granular material.

Reservoir 102 may comprise any suitable mechanism for conveying the animal feed from reservoir 102 to feed zones 108. Most simply, the animal feed will be gravity fed to feed zones 108. However, the present invention contemplates that active mechanical means may be utilized in place of or in conjunction with gravity feed to urge and/or convey the animal feed to the feed zones 108, non-limiting examples of which include, screw type feeders, conveyors, vibration, agitation, stiffing, shaking, paddles, air flow, liquid flow, magnetic agitators, sonic energy, and the like.

As a non-limiting example, reservoir 102 may have a sloping bottom surface to allow gravity feed of the animal feed through chutes 105 to feed zones 108. The slope of the sloping bottom surface and that of the chutes may be greater than the angle of repose of the solid material.

Reservoir 102 and feed zone 108 are in solids flow communication, that is, solids may pass from reservoir 102 to feed zone 108, whether by gravity flow or by mechanical assistance. Most conveniently, reservoir 102 and feed zone 108 are in solids gravity flow communication, that is, solids may pass from reservoir 102 to feed zone 108 by gravity flow. Reservoir 102 may directly open to a feed zone 108, or alternatively (as shown) one or more feed chutes 105 may connect reservoir 102 to one or more feed zones 108.

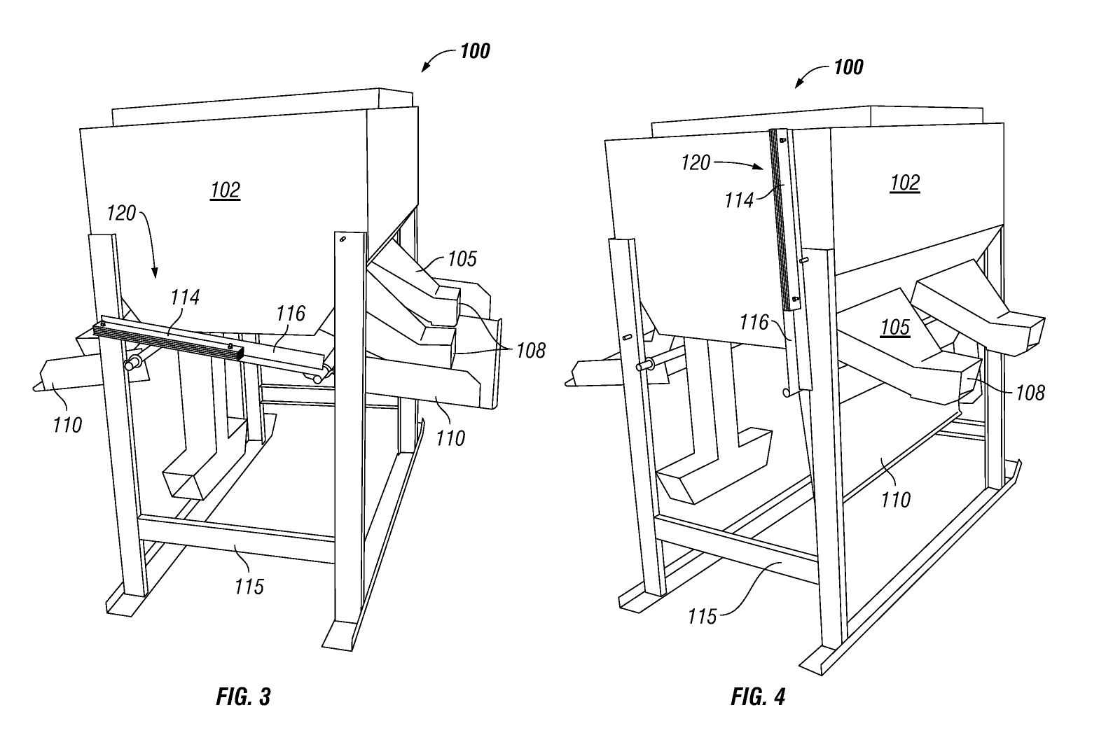

Animal feeder 100 may include tray 110 pivotally attached below feed zones 108. In the non-limiting embodiment as shown, tray 110 is pivotally attached to an elongated shaft 112, and is pivotable between a first position as shown in FIGS. 1-3, and a second position as shown in FIG. 4. Tray 110 may have a low friction surface to reduce the likelihood that a small mammalian pest will be able to get a firm footing/grip.

Animal feed 100 may further include a bias for urging tray 110 toward the first position. Any suitable mechanism for biasing tray 110 toward the first position may be utilized. As a non-limiting example, a counter weight mechanism may be utilized to bias tray 110 toward the first position. As another non-limiting example, a spring mechanism may be provided to bias tray 110 toward the first position. As another non-limiting example, a hydraulic mechanism that resists movement toward the second position and urges return to the first position may be utilized.

In the embodiment as shown in FIGS. 1-4, a counter weight system 120 includes an arm 116 affixed to shaft 112. Should the weight of arm 116 not be suitable, a weight 114 may be positioned anywhere along arm 116 to adjust the amount of bias. Certainly, weight 114 may be movably positioned on arm 116. As a non-limiting example, a spring mechanism may be provided to bias tray 110 toward the first position. As another non-limiting example, a hydraulic mechanism that resists movement toward the second position and urges return to the first position may be utilized. As even another non-limiting example, a counter weight mechanism may be utilized to bias tray 110 toward the first position.

The bias is generally selected so that the weight of the targeted undesirable species, for example, a small mammalian pest, will overcome the bias and urge and/or release tray 110 toward the second position. The small mammalian pest is then dropped from tray 110 away from feed zones 108. To reduce the likelihood of any pest hanging on to surrounding surfaces once the tray has pivoted, it is generally desirable to design any surfaces around tray 110 to be hostile to supporting the pest. That is, the surfaces around feed zones 108 and the surfaces of chutes 105, will be low friction and difficult to grip surfaces. For example, those surfaces may be convex and low friction.

In operation, a grazing animal will consume animal feed at feed zones 108. The consumption of animal feed at feed zone 108 will cause gravity flow of more feed from reservoir 102 to flow into feed zone 108. When an undesirable species, such as a small mammalian pest lands upon tray 110 in an effort to steal food at feed zone 108, the weight of the pest will overcome the bias and tray 110 will rotate toward the second position. The pest will not be able to maintain a footing and will be dropped away from feed zone 108.

Animal feeder 100 may be made of any suitable materials of construction, non-limiting examples of which include metal, plastic, ceramic, wood, stone, composites, and any combination of the foregoing. The selection of a suitable material of construction may be made after consideration of engineering and economic design factors. Most commonly, the material of construction will be galvanized iron, stainless steel or aluminum. While not meant to limit the claims in any manner, the inventor most likely will employ galvanized iron for material of construction.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

I claim:

1. An animal feeder comprising:
A feed reservoir;
A feed zone in solid flow communication with the feed reservoir; and,
A tray pivotally attached below the feed zone, the tray being pivotable between a first position and a second position.

2. The feeder of claim 1 wherein the first position is suitable for receiving a mammalian pest, and a second position not suitable for holding a mammalian pest.

3. The feeder of claim 1 wherein the solid flow communication is by gravity feed.

4. The feeder of claim 1, wherein the first position is horizontal and the second position is vertical.

5. The feeder of claim 1, wherein the tray is biased toward the first position.

6. The feeder of claim 1, wherein the tray is biased toward the first position, and the bias is adjustable.

7. The feeder of claim 1, wherein the tray is biased to return from the second position to the first position.

8. The feeder of claim 1, wherein the tray comprises a low friction surface.

9. An animal feeder comprising:
A feed reservoir;
Flowable solid animal feed positioned in the reservoir;
A feed zone receiving animal feed from the feed reservoir; and,
A tray pivotally attached below the feed zone, the tray being pivotable between a first position and a second position.

10. The feeder of claim 9, wherein the first position is suitable for receiving a mammalian pest, and a second position not suitable for holding a mammalian pest.

11. The feeder of claim 9 wherein the solid feed is gravity fed from the reservoir.

12. The feeder of claim 9, wherein the first position is horizontal and the second position is vertical.

13. The feeder of claim 9, wherein the tray is biased toward the first position.

14. The feeder of claim 9, wherein the tray is biased toward the first position, and the bias is adjustable.

15. The feeder of claim 9, wherein when the tray is biased to return from the second position to the first position.
